(19) United States
(12) Patent Application Publication
(10) Pub. No.: US 2026/0125039 A1
(43) Pub. Date: May 7, 2026

(54) BRAKE SYSTEM AND METHOD OF DETECTING FAILURE OF PEDAL TRAVEL SENSOR OF BRAKE SYSTEM

(71) Applicant: HL MANDO CORPORATION, Pyeongtaek-si (KR)

(72) Inventor: Chanhee LEE, Pyeongtaek-si (KR)

(21) Appl. No.: 19/009,070

(22) Filed: Jan. 3, 2025

(30) Foreign Application Priority Data
Nov. 1, 2024 (KR) 10-2024-0153524

(51) Int. Cl. B60T 17/22; B60T 7/04

(52) U.S. Cl. CPC B60T 17/22; B60T 7/042; B60T 2220/04; B60T 2270/406; B60T 2270/413

(57) ABSTRACT

A brake system may include at least one pedal travel sensor configured to detect a displacement of a brake pedal, and a controller is configured to acquire a pedal travel value on the basis of an output signal received from the at least one pedal travel sensor, and determine that the at least one pedal travel sensor fails on the basis that a difference value between first and second pedal travel values continuously acquired while the pedal travel value is acquired is greater than a predesignated reference value, and at least one pedal travel value, which is continuously acquired after the second pedal travel value is acquired, is equal to the second pedal travel value.

### CROSS-REFERENCE TO RELATED APPLICATIONS

This application claims the priority of Korean Patent Application No. 10-2024-0153524 filed on Nov. 1, 2024, in the Korean Intellectual Property Office, the disclosure of which is incorporated herein by reference.

### BACKGROUND

### Technical Field

The disclosed disclosure relates to a brake system and a method of detecting a failure of a pedal travel sensor of a brake system.

### Description of the Related Art

A brake pedal refers to a device configured to perform braking control on a vehicle in accordance with a driver's braking intention. When a displacement of the brake pedal is detected by a pedal travel sensor provided on the brake pedal, a corresponding signal is transmitted to a brake system, such that the brake system may be used to perform braking control on the vehicle.

However, when the pedal travel sensor for a brake pedal fails, the pedal travel sensor outputs an abnormal signal or outputs no signal even though the driver pushes the brake pedal, which causes a problem in that the brake system cannot perform normal braking control on the vehicle.

Therefore, in the related art, a technology has been developed in which a plurality of pedal travel sensors is provided on a brake pedal to provide redundancy of the pedal travel sensor. The pedal travel sensor for a brake pedal has various channels, such as two or three channels, depending on the type of vehicle, such that signals of different pedal travel sensors are provided to a brake system for respective channels.

### BRIEF SUMMARY

However, in the related art, in case that the number of channels of the pedal travel sensor for a brake pedal is three, there is a problem in that when fault injection is performed on two pedal travel sensors with the same pedal stroke, one normal pedal travel sensor is determined as being failed, and the two pedal travel sensors on which the fault injection is performed is determined as being normal.

An external pedal travel sensor may be connected to a controller (e.g., an electronic control device (ECU)) of the brake system through a hard wire, and the hard wire may be manipulated so that a distorted signal may be inputted to the pedal travel sensor when the signal is distorted with the same format as properties of an output signal of the pedal travel sensor.

In addition, in case that the pedal travel sensor outputs a signal through a single edge nibble transmission (SENT) protocol, the fault injection may be performed on the corresponding pedal travel sensor when the SENT protocol is hacked by a malicious user because the SENT protocol is an open protocol.

Therefore, the inventors of the present disclosure have recognized the need to develop a new technology capable of solving the problem in that two pedal travel sensors subjected to fault injection are determined as being normal, and one actually normal pedal travel sensor is determined as being failed when the three pedal travel sensors are provided on the brake pedal.

An object achieved by the disclosed disclosure is to provide a brake system, which is capable of providing a new failure diagnosis technology for a pedal travel sensor for a brake pedal, and a method of detecting a failure of a pedal travel sensor of a brake system.

Another object achieved by the disclosed disclosure is to provide a brake system, which is capable of diagnosing a failure of a pedal travel sensor for a brake pedal in accordance with fault injection, and a method of detecting a failure of a pedal travel sensor of a brake system.

Still another object achieved by the disclosed disclosure is to provide a brake system, which is capable of accurately identifying two pedal travel sensors, among three pedal travel sensors for a brake pedal, when detecting a failure by changing and outputting a signal with a value that cannot be outputted by physically changing output signals of the two pedal travel sensor in an allowable range (in-range), and a method of detecting a failure of a pedal travel sensor of a brake system.

Yet another object achieved by the disclosed disclosure is to provide a brake system, which is capable of improving a technology in the related art that determines both two pedal travel sensors as being failed because it is impossible to determine an accurate value in case that pedal travel values acquired from output signals of the two pedal travel sensors are different from each other when detecting failures of the two pedal travel sensors for a brake pedal, and a method of detecting a failure of a pedal travel sensor of a brake system.

For example, the brake system and the method of detecting a failure of a pedal travel sensor of a brake system, which improve the technology in the related art, may provide a technology capable of accurately identifying a pedal travel sensor, which outputs a signal with a value that cannot be outputted by physically changing output signals of the two pedal travel sensors in an allowable range, as a failed pedal travel sensor.

One aspect of the disclosed disclosure provides a brake system including: at least one pedal travel sensor configured to detect a displacement of a brake pedal; and a controller electrically connected to the at least one pedal travel sensor, in which the controller is configured to acquire a pedal travel value on the basis of an output signal received from the at least one pedal travel sensor, and determine that the at least one pedal travel sensor fails on the basis that a difference value between first pedal travel value and second pedal travel value continuously acquired while the pedal travel value is acquired is greater than a predesignated reference value, and at least one pedal travel value, which is continuously acquired after the second pedal travel value is acquired, is equal to the second pedal travel value.

The controller may acquire the pedal travel value on the basis of the output signal received from the at least one pedal travel sensor in each predesignated time cycle.

The controller may increase an error count value on the basis that each of the at least one pedal travel value, which is continuously acquired after the second pedal travel value is acquired, is equal to a pedal travel value in an immediately previous time cycle, and determine that the at least one pedal travel sensor fails on the basis that the increased error count value is greater than a predesignated reference error count.

The controller may compare the difference value and the predesignated reference value on the basis that the second pedal travel value is acquired in a second cycle continuing to a first cycle in which the second pedal travel value is acquired, and change a flag, which indicates a non-normal state of the at least one pedal travel sensor, to a set state and set the error count to 0 on the basis that the difference value is greater than the predesignated reference value.

The controller may increase the error count value further on the basis that a flag is a set state.

The controller may determine that the at least one pedal travel sensor is normal when the at least one pedal travel value, which is continuously acquired after the second pedal travel value is acquired, is different from the pedal travel value in the immediately previous time cycle or the flag is a non-set state while the increased error count value is equal to or smaller than the predesignated reference error count.

The controller may reset the flag and set the error count to 0 when the at least one pedal travel value, which is continuously acquired after the second pedal travel value is acquired, is different from the pedal travel value in the immediately previous time cycle or the flag is the non-set state while the increased error count value is equal to or smaller than the predesignated reference error count.

The controller may determine that the at least one pedal travel sensor is normal when the difference value is equal to or smaller than the predesignated reference value.

The at least one pedal travel sensor may include a first pedal travel sensor, a second pedal travel sensor, and a third pedal travel sensor, and the controller may perform additional failure diagnosis on the first pedal travel sensor, the second pedal travel sensor, and the third pedal travel sensor on the basis of comparison between a pedal travel value of the first pedal travel sensor, a pedal travel value of the second pedal travel sensor, and a pedal travel value of the third pedal travel sensor when the first pedal travel sensor, the second pedal travel sensor, and the third pedal travel sensor are determined as being normal.

The controller may determine that the third pedal travel sensor fails on the basis that a difference value between the pedal travel value of the first pedal travel sensor and the pedal travel value of the second pedal travel sensor is equal to or smaller than a predesignated reference difference value, and a difference value between the pedal travel value of the third pedal travel sensor and each of the pedal travel value of the first pedal travel sensor and the pedal travel value of the second pedal travel sensor is greater than the predesignated reference difference value.

Another aspect of the disclosed disclosure provides a method of detecting a failure of a pedal travel sensor of a brake system, the method including: acquiring a pedal travel value on the basis of an output signal received from at least one pedal travel sensor configured to detect a displacement of a brake pedal; and determining that the at least one pedal travel sensor fails on the basis that a difference value between first pedal travel value and second pedal travel value continuously acquired while the pedal travel value is acquired is greater than a predesignated reference value, and at least one pedal travel value, which is continuously acquired after the second pedal travel value is acquired, is equal to the second pedal travel value.

The acquiring of the pedal travel value on the basis of the output signal received from the at least one pedal travel sensor may be performed in each predesignated time cycle.

The method may further include: increasing an error count value on the basis that each of the at least one pedal travel value, which is continuously acquired after the second pedal travel value is acquired, is equal to a pedal travel value in an immediately previous time cycle, in which the determining that the at least one pedal travel sensor fails is performed on the basis that the increased error count value is greater than a predesignated reference error count.

The method may further include: comparing the difference value and the predesignated reference value on the basis that the second pedal travel value is acquired in a second cycle continuing to a first cycle in which the second pedal travel value is acquired; and changing a flag, which indicates a non-normal state of the at least one pedal travel sensor, to a set state and setting the error count to 0 on the basis that the difference value is greater than the predesignated reference value.

The increasing of the error count value may be performed on the basis that a flag is a set state.

The method may further include: determining that the at least one pedal travel sensor is normal when the at least one pedal travel value, which is continuously acquired after the second pedal travel value is acquired, is different from the pedal travel value in the immediately previous time cycle or the flag is a non-set state while the increased error count value is equal to or smaller than the predesignated reference error count.

The method may further include: resetting the flag and setting the error count to 0 when the at least one pedal travel value, which is continuously acquired after the second pedal travel value is acquired, is different from the pedal travel value in the immediately previous time cycle or the flag is the non-set state while the increased error count value is equal to or smaller than the predesignated reference error count.

The method may further include: determining that the at least one pedal travel sensor is normal when the difference value is equal to or smaller than the predesignated reference value.

The at least one pedal travel sensor may include a first pedal travel sensor, a second pedal travel sensor, and a third pedal travel sensor, and the method of detecting a failure of a pedal travel sensor may further include performing additional failure diagnosis on the first pedal travel sensor, the second pedal travel sensor, and the third pedal travel sensor on the basis of comparison between a pedal travel value of the first pedal travel sensor, a pedal travel value of the second pedal travel sensor, and a pedal travel value of the third pedal travel sensor when the first pedal travel sensor, the second pedal travel sensor, and the third pedal travel sensor are determined as being normal.

The performing of the additional failure diagnosis may include determining that the third pedal travel sensor fails on the basis that a difference value between the pedal travel value of the first pedal travel sensor and the pedal travel value of the second pedal travel sensor is equal to or smaller than a predesignated reference difference value, and a difference value between the pedal travel value of the third pedal travel sensor and each of the pedal travel value of the first pedal travel sensor and the pedal travel value of the second pedal travel sensor is greater than the predesignated reference difference value.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a block diagram illustrating some components of a brake system according to an embodiment;

FIG. 2 is a view illustrating arrangements and electrical connection of pedal travel sensors of the brake system according to the embodiment;

FIGS. 3A and 3B are a view illustrating an output signal of the pedal travel sensor for a brake pedal according to the embodiment;

FIG. 4 is a flowchart illustrating an operation of diagnosing a failure of the pedal travel sensor of the brake system according to the embodiment;

FIG. 5 is a flowchart illustrating the operation of diagnosing a failure of the pedal travel sensor of the brake system according to the embodiment;

FIG. 6 is a flowchart illustrating the operation of diagnosing a failure of the pedal travel sensor of the brake system according to the embodiment; and

FIG. 7 is a view illustrating output signals of first and second pedal travel sensors subjected to fault injection and an output signal of a third pedal travel sensor, which operates normally, according to the embodiment.

### DETAILED DESCRIPTION

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

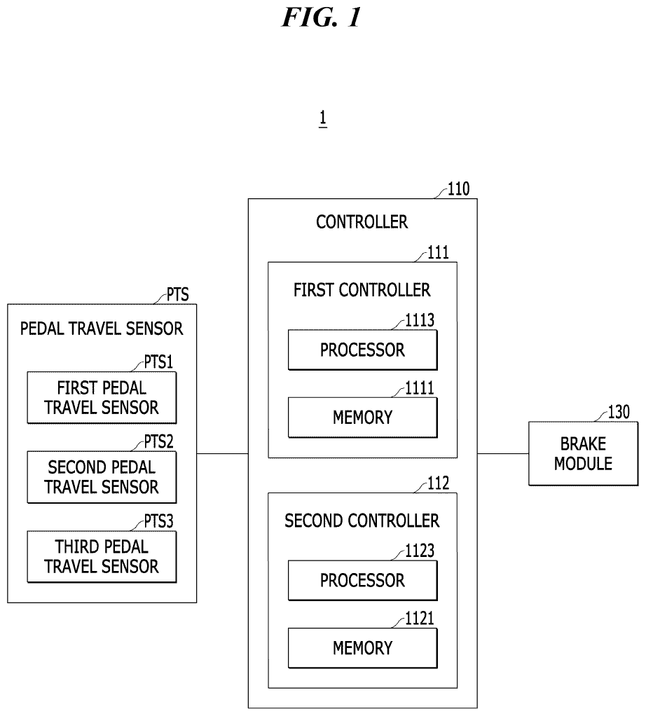

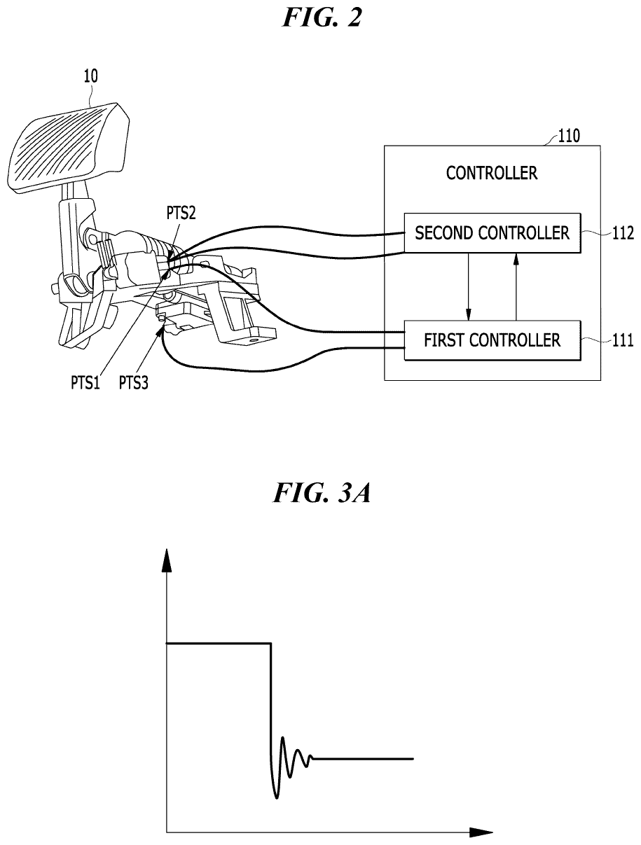

FIG. 1 is a block diagram illustrating some components of a brake system according to an embodiment. FIG. 2 is a view illustrating arrangements and electrical connection of pedal travel sensors of the brake system according to the embodiment.

With reference to FIGS. 1 and 2, a brake system 1 may include pedal travel sensors PTS, controllers 110, and/or a brake module 130.

The pedal travel sensor PTS may be provided on a brake pedal 10 and output a signal corresponding to a displacement of the brake pedal 10. The pedal travel sensor PTS may be provided as a single pedal travel sensor PTS or a plurality of pedal travel sensors PTS. The pedal travel sensors PTS may include a first pedal travel sensor PTS1, a second pedal travel sensor PTS2, and/or a third pedal travel sensor PTS3.

With reference to FIG. 2, the first brake pedal travel sensor PTS1 and the second brake pedal travel sensor PTS2 may be integrated into one package and mounted on a part of the brake pedal 10. In addition, the third brake pedal travel sensor PTS3 may be provided separately from the first brake pedal travel sensor PTS1 and the second brake pedal travel sensor PTS2 and mounted on another part of the brake pedal 10.

The controller 110 may control the entire brake system 1.

The controller 110 may be electrically connected to the pedal travel sensor PTS (e.g., the first pedal travel sensor PTS1, the second pedal travel sensor PTS2, and/or the third pedal travel sensor PTS3) and/or the brake module 130 and control the pedal travel sensor PTS and/or the brake module 130.

The controller 110 may diagnose a failure of the pedal travel sensor PTS, e.g., the first pedal travel sensor PTS1, the second pedal travel sensor PTS2, and the third pedal travel sensor PTS3.

The controller 110 may perform power supply failure diagnosis, communication connection failure diagnosis, cyclic redundancy check (CRC), sensor self-failure diagnosis, sensor output range exceeding failure diagnosis, and/or brake pedal travel range exceeding failure diagnosis on the first to third pedal travel sensors PTS1, PTS2, and PTS3. Because the power supply failure diagnosis, the communication connection failure diagnosis, the cyclic redundancy check (CRC), the sensor self-failure diagnosis, the sensor output range exceeding failure diagnosis, and/or the brake pedal travel range exceeding failure diagnosis are technologies in the related art, a detailed description thereof will be omitted.

The controller 110 may perform abnormal signal failure diagnosis on the first to third pedal travel sensors PTS1, PTS2, and PTS3.

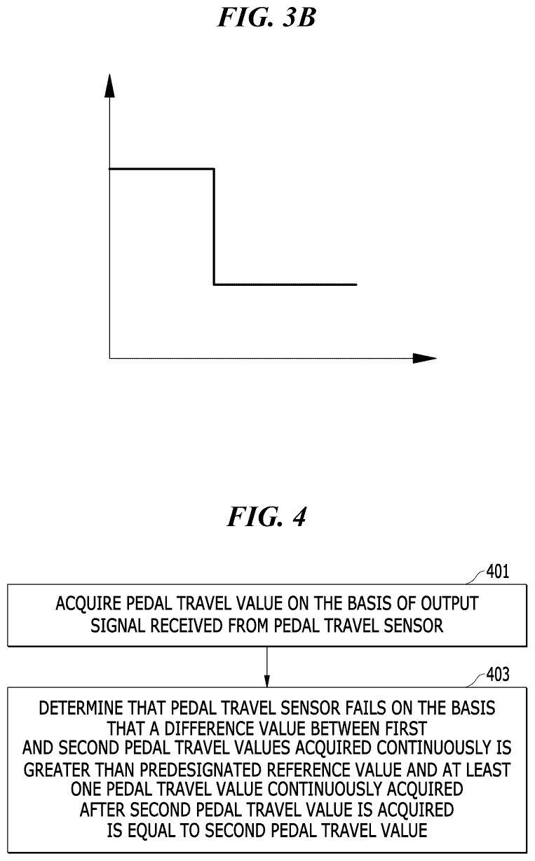

FIGS. 3A and 3B are a view illustrating an output signal of the pedal travel sensor for a brake pedal according to the embodiment.

With reference to FIG. 3A, in case that a pedal travel value, which is acquired from an output signal of the pedal travel sensor PTS by a physical change of the brake pedal 10, is suddenly changed, the output signal of the pedal travel sensor PTS has a shape in which a stable signal is outputted after overshooting and signal stabilization sections. However, with reference to FIG. 3B, in a failure state of the pedal travel sensor PTS made by fault injection, the output signal of the pedal travel sensor PTS does not create the signal stabilization section. Actually, it is physically impossible to generate a phenomenon in which the output values of the pedal travel sensors PTS are changed to large values at once and then stuck as the same value.

Therefore, the properties of the output signals of the pedal travel sensors PTS in FIGS. 3A and 3B are utilized for the abnormal signal failure diagnosis on the pedal travel sensors PTS in the embodiment of the disclosed disclosure. More specifically, in the embodiment of the disclosed disclosure, the controller 110 determines the pedal travel sensor PTS, which outputs a signal illustrated in FIG. 3A, as being normal, and determines the pedal travel sensor PTS, which outputs a signal illustrated in FIG. 3B, as being abnormal.

The controller 110 may acquire the pedal travel values by receiving the output signals from the first pedal travel sensor PTS1, the second pedal travel sensor PTS2, and/or the third pedal travel sensor PTS3 for a predesignated time in each predesignated time cycle. The controller 110 may perform the failure diagnosis that determines the corresponding pedal travel sensor as being failed on the basis that a difference value between first and second pedal travel values continuously acquired from the first pedal travel sensor PTS1, the second pedal travel sensor PTS2, and/or the third pedal travel sensor PTS3 during the process of acquiring the pedal travel value is greater than a predesignated reference value, and at least one pedal travel value, which is continuously acquired after the second pedal travel value is acquired, is equal to the second pedal travel value. The detailed embodiment of the abnormal signal failure diagnosis on the pedal travel sensor PTS will be described below.

In case that all the first to third pedal travel sensors PTS1, PTS2, and PTS3 are determined as being normal after the failure diagnosis on the first pedal travel sensor PTS1, the second pedal travel sensor PTS2, and/or the third pedal travel sensor PTS3 as described above, the controller 110 may additionally perform additional failure diagnosis on the first pedal travel sensor PTS1, the second pedal travel sensor PTS2, and the third pedal travel sensor PTS3 on the basis of the comparison between the pedal travel values acquired from the output signals of the first pedal travel sensor PTS1, the second pedal travel sensor PTS2, and the third pedal travel sensor PTS3.

For example, on the basis of a voting rule in the related art, the controller 110 may perform the additional failure diagnosis on the first pedal travel sensor PTS1, the second pedal travel sensor PTS2, and the third pedal travel sensor PTS3.

For example, the controller 110 may determine the third pedal travel sensor PTS3 as being failed on the basis that a difference value between the pedal travel value of the first pedal travel sensor PTS1 and the pedal travel value of the second pedal travel sensor PTS2 is equal to or smaller than a predesignated reference difference value, and a difference value between each of the first and second pedal travel values and the pedal travel value of the third pedal travel sensor PTS3 is greater than the predesignated reference difference value. For example, the pedal travel value of the first pedal travel sensor PTS1, the pedal travel value of the second pedal travel sensor PTS2, and the pedal travel value of the third pedal travel sensor PTS3 may be acquired in the same time cycle.

Meanwhile, the controllers 110 may include a first controller 111 and a second controller 112.

The first controller 111 may be electrically connected to the first pedal travel sensor PTS1, the second pedal travel sensor PTS2, the third pedal travel sensor PTS3, and/or the brake module 130 and control the first pedal travel sensor PTS1, the second pedal travel sensor PTS2, the third pedal travel sensor PTS3, and/or the brake module 130.

The first controller 111 may perform the above-mentioned failure diagnosis on the first pedal travel sensor PTS1, the second pedal travel sensor PTS2, and the third pedal travel sensor PTS3.

The first controller 111 may include a memory 1111 and a processor 1113.

The memory 1111 may store or memorize programs and data for implementing operations of controlling the components included in the first controller 111, i.e., operations of controlling the first controller 111.

The memory 1111 may provide the stored programs and data to the processor 1113 and memorize temporary data generated during the operation of the processor 1113.

For example, the memory 1111 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The processor 1113 may provide control signals for controlling the operations of the components included in the brake system 1.

The second controller 112 may be electrically connected to the first pedal travel sensor PTS1, the second pedal travel sensor PTS2, the third pedal travel sensor PTS3, and/or the brake module 130 and control the first pedal travel sensor PTS1, the second pedal travel sensor PTS2, the third pedal travel sensor PTS3, and/or the brake module 130. The second controller 112 may perform the above-mentioned failure diagnosis on the first pedal travel sensor PTS1, the second pedal travel sensor PTS2, and the third pedal travel sensor PTS3.

The second controller 112 may include a memory 1121 and a processor 1123.

The memory 1121 may store or memorize programs and data for implementing operations of controlling the components included in the second controller 112, i.e., operations of controlling the second controller 112.

The memory 1121 may provide the stored programs and data to the processor 1123 and memorize temporary data generated during the operation of the processor 1123.

For example, the memory 1121 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The processor 1123 may provide control signals for controlling the operations of the components included in the brake system 1.

Meanwhile, with reference to FIG. 2, as another example, the first pedal travel sensor PTS1 and the third pedal travel sensor PTS3 may be connected directly to the first controller 111, and the second pedal travel sensor PTS2 may be connected directly to the second controller 112.

In addition, the first controller 111 and the second controller 112 may communicate with or be electrically connected to each other. Therefore, the first controller 111 may transmit the output signal of the first pedal travel sensor PTS1 and the output signal of the third pedal travel sensor PTS3 to the second controller 112, and the second controller 112 may transmit the output signal of the second pedal travel sensor PTS2 to the first controller 111.

The brake module 130 may be connected to the brake pedal 10 and mechanically and/or electrically operated and controlled, such that liquid pressure of a pressing medium may be supplied to a wheel cylinder (not illustrated) provided in each wheel of the vehicle.

For example, although not illustrated, a brake module 10 may include a reservoir (not illustrated) configured to accommodate and store therein the pressing medium, an integrated master cylinder (not illustrated) configured to press and discharge the pressing medium accommodated therein while simultaneously providing the driver with a reaction force generated in response to a pedal effort of the brake pedal 10, a liquid pressure supply device (not illustrated) configured to generate liquid pressure of the pressing medium while mechanically operating by receiving the driver's braking intention as electrical signals from the first, second, and/or third pedal travel sensors PTS1, PTS2, and PTS3 configured to detect the displacement of the brake pedal 10, a hydraulic control unit (not illustrated) configured to control the liquid pressure provided from the liquid pressure supply device, a reservoir flow path (not illustrated) configured to hydraulically connect the reservoir and the integrated master cylinder, a dump control unit (not illustrated) between the liquid pressure supply device and the reservoir and configured to control a flow of the pressing medium, and a test flow path (not illustrated) provided to connect the integrated master cylinder and the liquid pressure supply device and configured to check whether various types of component elements leak.

In addition, although not illustrated, the brake module 130 may include a pair of pad plates (not illustrated) installed to press a brake disc (not illustrated) configured to rotate together with each of wheels FL, FR, RL, and RR of the vehicle, a caliper housing (not illustrated) configured to operate the pair of pad plates, a piston (not illustrated) installed in the caliper housing and configured to advance or retract, a power conversion unit (not illustrated) configured to receive rotational driving power for moving a piston, convert the rotational driving power into linear driving power, and transmit the linear driving power to the piston, and/or a brake motor configured to generate the rotational driving power for moving the piston.

Meanwhile, the above-mentioned first controller 111 may be a main controller, and the second controller 112 may be a sub-controller. Therefore, an overall operation of the brake system 1 may be controlled by the first controller 111. When the first controller 111 cannot operate, the second controller 112 may operate.

FIG. 4 is a flowchart illustrating an operation of diagnosing a failure of the pedal travel sensor of the brake system 1 (and/or the controller 110) according to the embodiment.

With reference to FIG. 4, the brake system 1 may acquire the pedal travel value on the basis of the output signal received from the pedal travel sensor PTS (or each of the first pedal travel sensor PTS1, the second pedal travel sensor PTS2, and the third pedal travel sensor PTS3) (401).

The brake system 1 may acquire the pedal travel value on the basis of the output signal received from the pedal travel sensor PTS for a predesignated time in each predesignated time cycle.

The brake system 1 may determine the pedal travel sensor PTS as being failed on the basis that the difference value between the first and second pedal travel values continuously acquired from the pedal travel sensors PTS is greater than the predesignated reference value, and at least one pedal travel value, which is continuously acquired after the second pedal travel value is acquired, is equal to the second pedal travel value while the pedal travel value is acquired on the basis of the output signal received from the pedal travel sensor PTS (403).

The brake system 1 may determine the pedal travel sensor PTS as being normal in case that the difference value between the first and second pedal travel values continuously acquired from the pedal travel sensors PTS is equal to or smaller than the predesignated reference value.

The brake system 1 may determine the pedal travel sensor PTS as being normal in case that at least one pedal travel value, which is continuously acquired after the second pedal travel value is acquired, is not equal to the second pedal travel value.

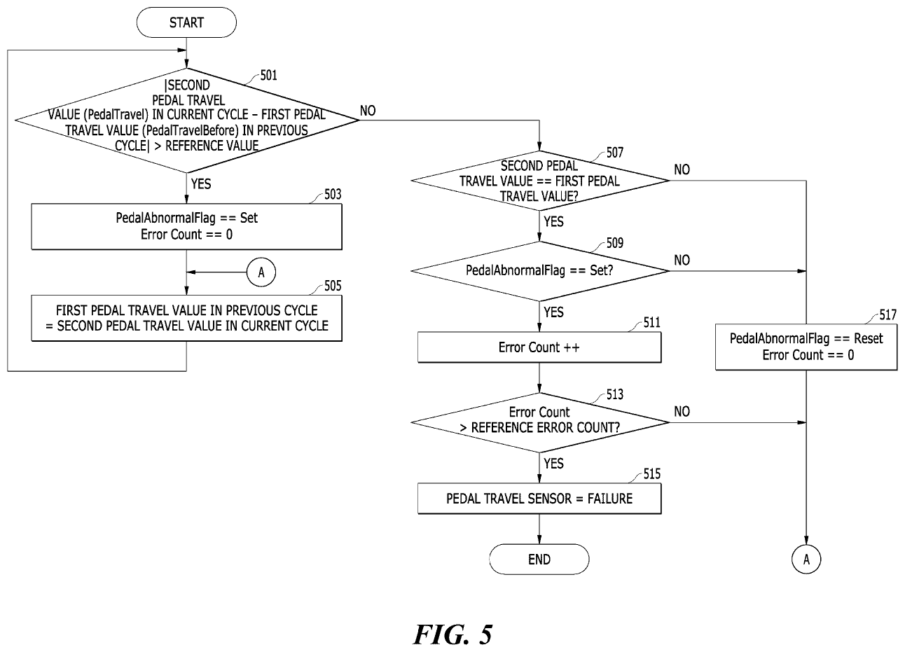

FIG. 5 is a flowchart illustrating an operation of diagnosing a failure of the pedal travel sensor of the brake system 1 (and/or the controller 110) according to the embodiment.

With reference to FIG. 5, the brake system 1 may determine whether a difference between a second pedal travel value (PedalTravel) according to an output signal in a current cycle (an n-th cycle, n is an integer) of each of the first pedal travel sensor PTS1, the second pedal travel sensor PTS2, and the third pedal travel sensor PTS3 and a first pedal travel value (PedalTravelBefore) according to an output signal in a previous cycle (an (n-1)th cycle) that is a cycle immediately before the current cycle is greater than a predesignated reference value (501).

The case in which the difference between the second pedal travel value (PedalTravel) in the current cycle (n-th cycle) and the first pedal travel value (PedalTravelBefore) in the previous cycle ((n-1)th cycle) is greater than the reference value in the brake system 1 means a case in which the brake pedal 10 is quickly pressed or released, such that the pedal travel value of the brake pedal 10 is changed to a large value at once.

In case that the difference between the second pedal travel value (PedalTravel) in the current cycle (n-th cycle) and the first pedal travel value (PedalTravelBefore) according to the output signal in the previous cycle ((n-1)th cycle) is greater than the predesignated reference value, the brake system 1 may perform operation 503. Otherwise, the brake system 1 may perform operation 507.

The brake system 1 may change a pedal abnormal flag (PedalAbnormalFlag) to a set (Set) state and set an error count (Error Count) to 0 (503).

The configuration in which the brake system 1 changes the pedal abnormal flag (PedalAbnormalFlag) to the set (Set) state and sets the error count (Error Count) to 0 may be a configuration in which as the pedal travel value of the brake pedal 10 is changed to a large value at once, the initial setting required to diagnose a failure of the pedal travel sensors PTS1, PTS2, and PTS3 is performed.

In response to operation 503 described above, operation 513 described below, or operation 517 described below, the brake system 1 may change the second pedal travel value in the current cycle to the first pedal travel value in the previous cycle and store the first pedal travel value (505).

In response to operation 501 or operation 519 described below, the brake system 1 may determine whether the second pedal travel value (PedalTravel) in the current cycle (n cycle) and the first displacement value (PedalTravelBefore) in the previous cycle (n-1 cycle) are equal to each other (or also referred to as ‘correspond to each other’) (507).

In case that the second displacement value (PedalTravel) and the first displacement value (PedalTravelBefore) are equal to each other, the brake system 1 may perform operation 509. Otherwise, the brake system 1 may perform operation 517.

The brake system 1 may determine whether the pedal abnormal flag (PedalAbnormalFlag) is the set (Set) state (509).

In case that the pedal abnormal flag (PedalAbnormalFlag) is the set (Set) state, the brake system 1 may perform operation 511. Otherwise, the brake system 1 may perform operation 517.

The brake system 1 may determine whether the error count (Error Count) is greater than a predesignated reference error count (513).

In case that the error count (Error Count) is greater than the predesignated reference error count, the brake system 1 may perform operation 515. Otherwise, the brake system 1 may perform operation 519.

In response to operation 513, the brake system 1 may determine the corresponding pedal travel sensors PTS1, PTS2, and PTS3 as being failed, i.e., determine a result of the abnormal signal failure diagnosis on the corresponding pedal travel sensors PTS1, PTS2, and PTS3 as a failure (AbnormalSignalFault=Fault) (515).

In response to operation 507 or 509 described above, the brake system 1 may reset the pedal abnormal flag (PedalAbnormalFlag) and set the error count (Error Count) to 0 (517).

In addition to the above-mentioned embodiment in FIG. 5, on the basis that the pedal travel sensors PTS1, PTS2, and PTS3 are determined as being failed, the brake system 1 may transmit the corresponding result to a control device of the vehicle through a communication circuit (not illustrated) so that the corresponding result is outputted through an output device (not illustrated) of the vehicle.

According to the above-mentioned embodiment in FIG. 5, the pedal travel values acquired from the output signals of the pedal travel sensors PTS1, PTS2, and PTS3 cannot be physically stuck in the same value after being changed to a large value at once. Therefore, the brake system 1 may determine the pedal travel sensor as being failed when the corresponding signal or pedal travel value is identified by monitoring the output signals of the pedal travel sensors PTS1, PTS2, and PTS3 and/or monitoring the amount of change in pedal travel values acquired from the output signals.

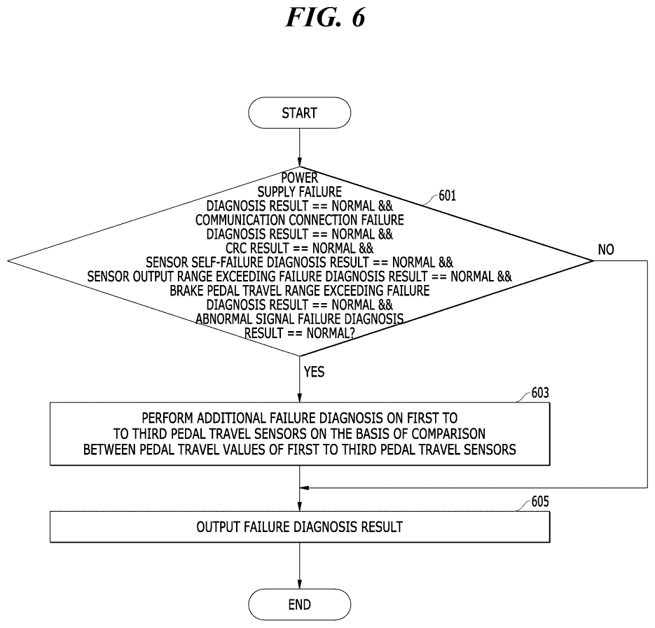

FIG. 6 is a flowchart illustrating an operation of diagnosing a failure of the pedal travel sensor of the brake system 1 (and/or the controller 10) according to the embodiment.

With reference to FIG. 6, on the first to third pedal travel sensors PTS1, PTS2, and PTS3, the brake system 1 may determine whether a power supply failure diagnosis result is normal, whether a communication connection failure diagnosis result is normal, whether a cyclic redundancy check (CRC) result is normal, whether a sensor self-failure diagnosis result is normal, whether a sensor output range exceeding failure diagnosis result is normal, whether a brake pedal travel range exceeding failure diagnosis result is normal, and whether an abnormal signal failure diagnosis result is normal (601).

The power supply failure diagnosis, the communication connection failure diagnosis, the cyclic redundancy check (CRC), the sensor self-failure diagnosis, the sensor output range exceeding failure diagnosis, and the brake pedal travel range exceeding failure diagnosis of the pedal travel sensor PTS may be performed by applying one of the technologies developed in the related art.

The abnormal signal failure diagnosis may be performed according to the above-mentioned embodiment in FIG. 5.

For example, in case that the first pedal travel value is acquired on the basis of the output signal received from the pedal travel sensor PTS in the first cycle and the second pedal travel value is acquired on the basis of the output signal received from the pedal travel sensor PTS in the second cycle, the brake system 1 may determine whether the difference value between the first pedal travel value and the second pedal travel value is greater than the predesignated reference value.

The brake system 1 may determine the pedal travel sensor PTS as being normal in case that the difference value between the first and second pedal travel values is equal to or smaller than the predesignated reference value.

In case that the difference value between the first and second pedal travel values is greater than the predesignated reference value, the brake system 1 may acquire a third pedal travel value on the basis of the output signal received from the pedal travel sensor PTS in a third cycle after the second cycle and identify whether the third pedal travel value is equal to the second pedal travel value in the second cycle.

The brake system 1 may determine the pedal travel sensor PTS as being normal in case that the third pedal travel value is different from the second pedal travel value in the second cycle.

In case that the third pedal travel value is equal to the second pedal travel value in the second cycle, the brake system 1 may set the error count value to 1 and determine whether the pedal travel value acquired on the basis of the output signal of the pedal travel sensor PTS for each subsequent cycle is equal to the pedal travel value in the cycle immediately before the corresponding cycle. In case that the pedal travel value acquired on the basis of the output signal of the pedal travel sensor PTS for each subsequent cycle is equal to the pedal travel value in the cycle immediately before the corresponding cycle, the brake system 1 may increase the error count value by 1. The increase in error count value may be repeated until the error count value becomes a value greater than a predesignated reference error count value or until the pedal travel values in the two cycles are different from each other.

When the error count value becomes the value greater than the predesignated reference error count value by the above-mentioned operation, the brake system 1 may determine the corresponding pedal travel sensor PTS as being failed.

In contrast, in case that the pedal travel values in the two cycles are different from each other before the error count value becomes the value greater than the predesignated reference error count value, the brake system 1 may reset the error count value and determine the corresponding pedal travel sensor PTS as being normal.

In case that all the power supply failure diagnosis result, the communication connection failure diagnosis result, the cyclic redundancy check (CRC) result, the sensor self-failure diagnosis result, the sensor output range exceeding failure diagnosis result, the brake pedal travel range exceeding failure diagnosis result, and the abnormal signal failure diagnosis result are determined as being normal on the first to third pedal travel sensors PTS1, PTS2, and PTS3, the brake system 1 may perform operation 603. Otherwise, the brake system 1 may perform operation 605.

The brake system 1 may perform the additional failure diagnosis on the first to third pedal travel sensors PTS1, PTS2, and PTS3 on the basis of the comparison between the pedal travel values of the first to third pedal travel sensors PTS1, PTS2, and PTS3 (603).

The brake system 1 may determine that all the first to third pedal travel sensors PTS1, PTS2, and PTS3 are normal in case that the difference between the pedal travel value of the first pedal travel sensor PTS1, the pedal travel value of the second pedal travel sensor PTS2, and the pedal travel value of the third pedal travel sensor PTS3, which are acquired in the same time cycle, is equal to or smaller than the predesignated reference difference value.

The brake system 1 may determine that the first pedal travel sensor PTS1 and the second pedal travel sensor PTS2 are normal and the third pedal travel sensor PTS3 is failed in case that the difference between the pedal travel value of the first pedal travel sensor PTS1 and the pedal travel value of the second pedal travel sensor PTS2 is equal to or smaller than the predesignated reference difference value, and the difference between the pedal travel value of the third pedal travel sensor PTS3 and each of the pedal travel value of the first pedal travel sensor PTS1 and the pedal travel value of the second pedal travel sensor PTS2 is greater than the predesignated reference difference value.

In response to operation 601 or 603 described above, the brake system 1 may output the failure diagnosis result (605).

Meanwhile, according to the above-mentioned embodiment in FIG. 6, the configuration has been described in which at operation 601, whether the plurality of failure diagnosis results is normal is determined on the first to third pedal travel sensors PTS1, PTS2, and PTS3.

However, according to another embodiment, at least one of the plurality of failure diagnosis results on the first to third pedal travel sensors PTS1, PTS2, and PTS3 at operation 601 may be excluded. In addition, a process of determining whether another failure diagnosis result in the related art is normal may be further added.

For example, among the power supply failure diagnosis, the communication connection failure diagnosis, the cyclic redundancy check (CRC), the sensor self-failure diagnosis, the sensor output range exceeding failure diagnosis, and the brake pedal travel range exceeding failure diagnosis on the first to third pedal travel sensors PTS1, PTS2, and PTS3, at least one failure diagnosis may be excluded, and whether the remaining failure diagnosis results are normal may be determined. When it is determined that the remaining failure diagnosis results are normal, operation 603 may be performed.

In addition, according to the above-mentioned embodiment in FIG. 6, the brake system 1 may perform the abnormal signal failure diagnosis on the first to third pedal travel sensors PTS1, PTS2, and PTS3.

Therefore, in case that the pedal travel values acquired from the output signals of the first to third pedal travel sensors PTS1, PTS2, and PTS3 are changed to values that cannot be outputted by the physical change in the allowable range (in-range), a failure of the corresponding pedal travel sensor may be detected in accordance with the abnormal signal failure diagnosis.

In addition, the brake system 1 may perform the additional failure diagnosis by comparing the pedal travel values on the basis of the output signals of the first to third pedal travel sensors PTS1, PTS2, and PTS3 after the abnormal signal failure diagnosis on the first to third pedal travel sensors PTS1, PTS2, and PTS3.

Therefore, for example, even in case that the first pedal travel sensor PTS1 and the second pedal travel sensor PTS2 simultaneously fail, the failure of the first pedal travel sensor PTS1 and the failure of the second pedal travel sensor PTS2 are detected by the abnormal signal failure diagnosis before the additional failure diagnosis performed by comparing the pedal travel values of the first to third pedal travel sensors PTS1, PTS2, and PTS3, thereby preventing an erroneous operation of determining that the first pedal travel sensor PTS1 and the second pedal travel sensor PTS2 are normal and the third pedal travel sensor PTS3 is failed during the additional failure diagnosis process.

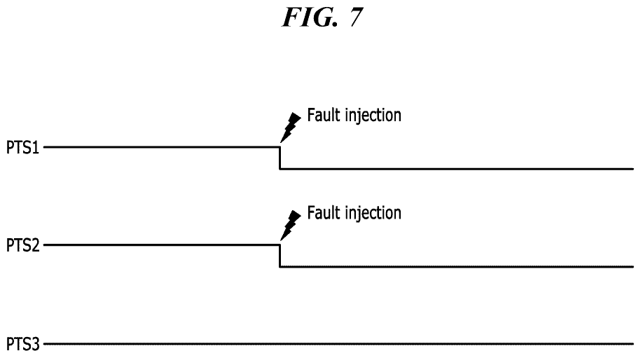

FIG. 7 is a view illustrating output signals of the first and second pedal travel sensors subjected to fault injection and an output signal of the third pedal travel sensor, which operates normally, according to the embodiment.

With reference to FIG. 7, when a fault injection device performs fault injection on the first pedal travel sensor PTS1 and the second pedal travel sensor PTS2, the output signals of the first pedal travel sensor PTS1 and the second pedal travel sensor PTS2 are jumped to values, which cannot be physically changed, and then stuck as a single value.

In contrast, the output signal of the third pedal travel sensor PTS3, which operates normally without being subjected to the fault injection, may be kept having a constant value.

For this reason, when the failure diagnosis is performed on the first to third pedal travel sensors PTS1, PTS2, and PTS3 by comparing the pedal travel values of the first to third pedal travel sensors PTS1, PTS2, and PTS3 in the related art, there occurs a problem in that the first and second pedal travel sensors PTS1 and PTS2, which actually fail, are determined as being normal, the third pedal travel sensor PTS3, which is actually normal, is determined as being failed, and the brake system 1 performs inadvertent control such as under-braking or over-braking.

In contrast, according to the above-mentioned embodiment, the brake system 1 may perform the additional failure diagnosis by comparing the pedal travel values on the basis of the output signals of the first to third pedal travel sensors PTS1, PTS2, and PTS3 after the abnormal signal failure diagnosis on the first to third pedal travel sensors PTS1, PTS2, and PTS3.

Therefore, the brake system 1 may determine that the first pedal travel sensor PTS1 and the second pedal travel sensor PTS2 are failed and the third pedal travel sensor PTS3 is normal by means of the abnormal signal failure diagnosis on the first to third pedal travel sensors PTS1, PTS2, and PTS3 and exclude the additional failure diagnosis.

Therefore, unlike the related art, the brake system 1 may determine that the first pedal travel sensor PTS1 and the second pedal travel sensor PTS2, which actually fail, are failed, and the brake system 1 may perform appropriate braking control on the basis of the output signal of the third pedal travel sensor PTS3 that is actually normal.

Meanwhile, in addition to the above-mentioned embodiment, in case that all the first to third pedal travel sensors PTS1, PTS2, and PTS3 are simultaneously failed, the brake system 1 may switch to a preset safety state mode and more safely perform braking control in comparison with the case in which the braking control is performed on the basis of the stuck pedal travel value of the pedal travel sensor.

The brake system 1 according to the above-mentioned embodiments may provide the new failure diagnosis technology on the pedal travel sensors PTS1, PTS2, and PTS3 for the brake pedal 10.

In addition, the brake system 1 may diagnose failures of the pedal travel sensors PTS1, PTS2, and PTS3 for the brake pedal 10 according to the fault injection.

In addition, the brake system 1 may accurately identify the two pedal travel sensors, among the three pedal travel sensors PTS1, PTS2, and PTS3 for the brake pedal 10, when detecting a failure by changing and outputting a signal with a value that cannot be outputted by physically changing output signals of the two pedal travel sensor in an allowable range (in-range).

The brake system 1 may improve a technology in the related art that determines both two pedal travel sensors as being failed because it is impossible to determine an accurate value in case that pedal travel values acquired from output signals of the two pedal travel sensors are different from each other when detecting failures of the two pedal travel sensors for the brake pedal 10.

For example, the brake system 1 may provide a technology capable of accurately identifying the pedal travel sensor, which outputs a signal with a value that cannot be outputted by physically changing output signals of the two pedal travel sensors in an allowable range, as a failed pedal travel sensor.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

1. A brake system comprising:
at least one pedal travel sensor configured to detect a displacement of a brake pedal; and
a controller electrically connected to the at least one pedal travel sensor,
wherein the controller is configured to acquire a pedal travel value on the basis of an output signal received from the at least one pedal travel sensor, and
determine that the at least one pedal travel sensor fails on the basis that a difference value between first pedal travel value and second pedal travel value continuously acquired while the pedal travel value is acquired is greater than a predesignated reference value, and at least one pedal travel value, which is continuously acquired after the second pedal travel value is acquired, is equal to the second pedal travel value.

2. The brake system of claim 1, wherein the controller is configured to acquire the pedal travel value on the basis of the output signal received from the at least one pedal travel sensor in each predesignated time cycle.

3. The brake system of claim 2, wherein the controller is configured to increase an error count value on the basis that each of the at least one pedal travel value, which is continuously acquired after the second pedal travel value is acquired, is equal to a pedal travel value in an immediately previous time cycle, and
determine that the at least one pedal travel sensor fails on the basis that the increased error count value is greater than a predesignated reference error count.

4. The brake system of claim 3, wherein the controller is configured to compare the difference value and the predesignated reference value on the basis that the second pedal travel value is acquired in a second cycle continuing to a first cycle in which the second pedal travel value is acquired, and
change a flag, which indicates a non-normal state of the at least one pedal travel sensor, to a set state and set the error count to 0 on the basis that the difference value is greater than the predesignated reference value.

5. The brake system of claim 3, wherein the controller is configured to increase the error count value further on the basis that a flag is a set state.

6. The brake system of claim 5, wherein the controller is configured to determine that the at least one pedal travel sensor is normal when the at least one pedal travel value, which is continuously acquired after the second pedal travel value is acquired, is different from the pedal travel value in the immediately previous time cycle or the flag is a non-set state while the increased error count value is equal to or smaller than the predesignated reference error count.

7. The brake system of claim 6, wherein the controller is configured to reset the flag and set the error count to 0 when the at least one pedal travel value, which is continuously acquired after the second pedal travel value is acquired, is different from the pedal travel value in the immediately previous time cycle or the flag is the non-set state while the increased error count value is equal to or smaller than the predesignated reference error count.

8. The brake system of claim 6, wherein the controller is configured to determine that the at least one pedal travel sensor is normal when the difference value is equal to or smaller than the predesignated reference value.

9. The brake system of claim 8, wherein the at least one pedal travel sensor comprises a first pedal travel sensor, a second pedal travel sensor, and a third pedal travel sensor, and
wherein the controller is configured to perform additional failure diagnosis on the first pedal travel sensor, the second pedal travel sensor, and the third pedal travel sensor on the basis of comparison between a pedal travel value of the first pedal travel sensor, a pedal travel value of the second pedal travel sensor, and a pedal travel value of the third pedal travel sensor when the first pedal travel sensor, the second pedal travel sensor, and the third pedal travel sensor are determined as being normal.

10. The brake system of claim 9, wherein the controller is configured to determine that the third pedal travel sensor fails on the basis that a difference value between the pedal travel value of the first pedal travel sensor and the pedal travel value of the second pedal travel sensor is equal to or smaller than a predesignated reference difference value, and a difference value between the pedal travel value of the third pedal travel sensor and each of the pedal travel value of the first pedal travel sensor and the pedal travel value of the second pedal travel sensor is greater than the predesignated reference difference value.

11. A method of detecting a failure of a pedal travel sensor of a brake system, the method comprising:
acquiring a pedal travel value on the basis of an output signal received from at least one pedal travel sensor configured to detect a displacement of a brake pedal; and
determining that the at least one pedal travel sensor fails on the basis that a difference value between first pedal travel value and second pedal travel value continuously acquired while the pedal travel value is acquired is greater than a predesignated reference value, and at least one pedal travel value, which is continuously acquired after the second pedal travel value is acquired, is equal to the second pedal travel value.

12. The method of claim 11, wherein the acquiring of the pedal travel value on the basis of the output signal received from the at least one pedal travel sensor is performed in each predesignated time cycle.

13. The method of claim 12, further comprising:
increasing an error count value on the basis that each of the at least one pedal travel value, which is continuously acquired after the second pedal travel value is acquired, is equal to a pedal travel value in an immediately previous time cycle,
wherein the determining that the at least one pedal travel sensor fails is performed on the basis that the increased error count value is greater than a predesignated reference error count.

14. The method of claim 13, further comprising:
comparing the difference value and the predesignated reference value on the basis that the second pedal travel value is acquired in a second cycle continuing to a first cycle in which the second pedal travel value is acquired; and
changing a flag, which indicates a non-normal state of the at least one pedal travel sensor, to a set state and setting the error count to 0 on the basis that the difference value is greater than the predesignated reference value.

15. The method of claim 13, wherein the increasing of the error count value is performed on the basis that a flag is a set state.

16. The method of claim 15, further comprising:
determining that the at least one pedal travel sensor is normal when the at least one pedal travel value, which is continuously acquired after the second pedal travel value is acquired, is different from the pedal travel value in the immediately previous time cycle or the flag is a non-set state while the increased error count value is equal to or smaller than the predesignated reference error count.

17. The method of claim 16, further comprising:
resetting the flag and setting the error count to 0 when the at least one pedal travel value, which is continuously acquired after the second pedal travel value is acquired, is different from the pedal travel value in the immediately previous time cycle or the flag is the non-set state while the increased error count value is equal to or smaller than the predesignated reference error count.

18. The method of claim 11, further comprising:
determining that the at least one pedal travel sensor is normal when the difference value is equal to or smaller than the predesignated reference value.

19. The method of claim 18, wherein the at least one pedal travel sensor comprises a first pedal travel sensor, a second pedal travel sensor, and a third pedal travel sensor, and
wherein the method of detecting a failure of a pedal travel sensor further comprises performing additional failure diagnosis on the first pedal travel sensor, the second pedal travel sensor, and the third pedal travel sensor on the basis of comparison between a pedal travel value of the first pedal travel sensor, a pedal travel value of the second pedal travel sensor, and a pedal travel value of the third pedal travel sensor when the first pedal travel sensor, the second pedal travel sensor, and the third pedal travel sensor are determined as being normal.

20. The method of claim 19, wherein the performing of the additional failure diagnosis comprises determining that the third pedal travel sensor fails on the basis that a difference value between the pedal travel value of the first pedal travel sensor and the pedal travel value of the second pedal travel sensor is equal to or smaller than a predesignated reference difference value, and a difference value between the pedal travel value of the third pedal travel sensor and each of the pedal travel value of the first pedal travel sensor and the pedal travel value of the second pedal travel sensor is greater than the predesignated reference difference value.
